(19) United States
(12) Patent Application Publication
(10) Pub. No.: US 2026/0291300 A1
(43) Pub. Date: Sep. 24, 2026

(54) CURRENT TRANSMISSION DEVICE FOR EXTERNALLY EXCITED SYNCHRONOUS MACHINES HAVING SEGMENTED FERRITE CORES

(71) Applicant: ZF FRIEDRICHSHAFEN AG, Friedrichshafen (DE)

(72) Inventors: Tobias DIECKHOFF, Würzburg (DE); Philipp KRAFT, Würzburg (DE); Robin MICHELBERGER, Schweinfurt (DE)

(21) Appl. No.: 19/474,252

(22) PCT Filed: Apr. 11, 2024
(86) PCT No.: PCT/EP2024/059805

§ 371 Date: Oct. 10, 2025

(30) Foreign Application Priority Data
Apr. 13, 2023 (DE) 10 2023 203 363.1

(51) Int. Cl. H02K 1/16; H01F 38/18; H02K 1/26; H02K 7/00

(52) U.S. Cl. CPC H02K 1/16; H01F 38/18; H02K 1/26; H02K 7/003

(57) ABSTRACT

A current transmission device for a separately excited synchronous machine includes a stator comprising a ferrite core and a rotor having a further ferrite core. At least one coil can be arranged at the ferrite core, at least one further coil can be arranged at the further ferrite core, the rotor is connected to the stator in a rotatably supported manner, and at least one of the ferrite cores comprises a plurality of ferrite segments which are receivable in a receiving matrix so that current can be transmitted contactlessly between the coil and the further coil by induction.

### CROSS REFERENCE TO RELATED APPLICATIONS

This is a U.S. national stage of Application No. PCT/EP2024/059805 filed Apr. 11, 2024. Priority is claimed on German Patent Application No. DE 10 2023 203 363.1 filed Apr. 13, 2023, the contents of which are incorporated herein by reference.

### BACKGROUND OF THE INVENTION

### 1. Field of the Invention

The disclosure is directed to a current transmission device for a separately excited synchronous machine with segmented ferrite cores, which current transmission device provides current for the coils of the rotor of the separately excited synchronous machine.

### 2. Description of the Related Art

Separately excited synchronous machines are well known. They have coils in both the rotor and the stator. Accordingly, there must be current transmission into the rotor. A number of possibilities for energizing the rotor coils of a separately excited synchronous machine are known from the prior art. In this regard, a contactless current transmission is advantageous because wear is reduced compared with slip contacts, for example.

Some solutions propose a transformer as rotary transformer for energizing the rotor coils. In this way, a contactless transmission of current can be carried out by induction. As a rule, the transformer comprises two ferrite cores, which are arranged radially nested one inside the other, for example, as well as associated coils which generate an electrical field that is concentrated by the ferrite cores. The two ferrite cores are separated from one another by the smallest possible air gap.

Such ferrite cores may be produced from ferrite powder by sintering methods; however, this gives rise to tolerance requirements for the yokes that can only be met in sintered component parts by subsequent machining.

### SUMMARY OF THE INVENTION

It is an object of one aspect of the present invention to provide ferrite cores which are configured by segmentation such that a subsequent machining is partially obviated and, where this is not the case, the ferrite cores can more easily be scaled for large production quantities.

It is a further object of one aspect of the present invention to suggest a technical solution for reducing production costs for ferrite cores while retaining the necessary precision (tolerances).

According to one aspect of the invention, a current transmission device for a separately excited synchronous machine comprises a stator comprising a ferrite core and a rotor comprising a further ferrite core. At least one coil can be arranged at the ferrite core, at least one further coil can be arranged at the further ferrite core, the rotor is connected to the stator so as to be rotatably mounted, and at least one of the ferrite cores comprises a plurality of ferrite segments which are receivable in a receiving matrix such that current can be transmitted between the coil and the further coil in a contactless manner by induction.

Ferrite cores are produced by compressing ferrite powder and subsequently sintering the blank. In so doing, the material is subject to wide fluctuations and significant shrinkage occurs. Accordingly, while this manufacturing process is very economical on the one hand, geometric tolerances can only be adhered to comparatively roughly.

This is problematic in the present application because the transformer core of the current transmission device is constructed in two parts and the primary-side part and secondary-side part are rotatable relative to one another. The primary-side part and secondary-side part are the ferrite cores in the stator and rotor of the current transmission device.

For low-loss operation, it is desirable that the air gaps between the cores be as slender as possible. However, under no circumstances should there be any contact therebetween. Rough geometric tolerances stand in conflict with these requirements.

Reduced tolerances during production is possible, for example, by subsequent cutting machining. However, this significantly increases production costs. In particular, such grinding or milling processes in which a bore hole (inner wall) is machined are particularly expensive because a small tool must be used at high speed for this purpose.

Unlike with closed, toroidal cores, the air gap length may be changed in the individual segments, for example, by displacing the inner segment. In the case of two toroidal cores, a radial displacement of the cores relative to one another would decrease the air gap at one location but increase it by the same amount at the opposite position.

Accordingly, the geometric tolerance for one of the two air gaps can ideally be compensated up to zero by segmentation and by displacement of two segments relative to one another.

Further, a final cutting machining of the ferrite may be necessary in order to reduce the geometric tolerance of the other air gap.

The outer ferrite core alone may also be constructed in a segmented manner. This is particularly the case when, owing to its smaller size or easier machinability, segmentation of the inner ferrite core is not worthwhile for reasons of cost or effort.

The coils may be cylindrical coils. Further, the rotor may be connected to a rotor of the separately excited synchronous machine and, as the secondary-side part of the current transmission device, can supply current to the rotor of the separately excited synchronous machine for operating the separately excited synchronous machine.

The stator of the current transmission device can be connected to the stator or housing of the separately excited synchronous machine and, as primary-side part of the current transmission device, can receive the current needed for operation of the rotor of the separately excited synchronous machine and transmit it to the secondary-side part by induction.

The rotor and stator of the current transmission device are connected to one another so as to be rotatably mounted. For example, one of the two is mounted on a shaft which is connected to the housing of the other by bearings.

There are implementations in which the receiving matrix comprises plastic.

In order to improve the magnetic properties of the segmented core, the plastic used may contain additions that increase its electrical permeability.

There are implementations in which the receiving matrix is produced by a primary forming process, in particular injection molding, and the ferrite segments are embedded in this primary forming process.

This allows a receiving matrix to be produced in a scalable manner.

There are implementations in which the ferrite segments have slots that are at least partially filled by the receiving matrix in the installed state.

Overmolding the segments, in particular with plastic, particularly in the area of contours and positively-engaging members, such as slots or keys, can serve to prevent relative rotation of adjoining components.

There are implementations in which at least the coil or the further coil can be contacted by at least one slot arranged between two ferrite segments of the respective ferrite core, and the coil or the further coil can be arranged at the ferrite core through whose slot they can be contacted.

A contacting channel can be provided which electrically insulates the contacts from the ferrite segments or ferrite cores.

There are implementations in which at least the coil or the further coil can be contacted through an opening which is arranged in one of the ferrite segments or, if the ferrite core is not segmented, is arranged in the ferrite core, and the coil or the further coil can be arranged at the ferrite core through whose opening they can be contacted.

A contacting channel can be provided which electrically insulates the contacts from the ferrite segments or ferrite cores.

There are implementations in which the ferrite core can be arranged radially inside of the further ferrite core, or the further ferrite core can be arranged radially inside of the ferrite core and, in the arranged state, two air gaps are formed between the ferrite core and the further ferrite core, which two air gaps are located at the two axial ends of the ferrite cores and are formed between outer lateral surfaces of the radially inner ferrite core and the inner lateral surfaces of the radially outer ferrite core, and the coil and the further coil can be arranged in a space between the two air gaps.

This provides a transformer with a primary-side part and a secondary side part, and the primary-side part and the secondary side part can be rotated relative to one another.

There are implementations in which the stator ferrite segments and rotor ferrite segments are of unequal width such that, at each rotational angle, the sum of the opposing ferrite segment lateral surfaces of the ferrite core and of the further ferrite core remains constant.

If the two ferrite cores are evenly segmented and rotate relative to one another, there are angular positions in which the inner segments and outer segments overlap exactly. In other angular positions, the gap between two segments lies opposite a closed segment area of the other core. This leads to fluctuations in inductance depending on the rotor position.

To prevent this, the segments can be designed with unequal widths. In particular, this can be effected in such a way that the sum of the opposing ferrite segment lateral surface areas of the inner core and outer core which form the air gap remains constant at every rotational angle.

A separately excited synchronous machine with a current transmission device according to one of the previous implementations is in accordance with one aspect of the invention.

An apparatus with a separately excited synchronous machine according to the previous implementation is in accordance with one aspect of the invention.

The apparatus may be, for example, a passenger car, but can also include any form of goods transport or passenger transport, such as trucks, buses, vans, trains, subways, trams, boats, and ships.

In addition, the apparatus may comprise, for example, work machines, such as, e.g., construction vehicles, forestry vehicles and agricultural vehicles, as well as construction machines, forestry machines and agricultural machines.

For example, the apparatus may be a machine from the domain of conveying engineering or a machine of a production installation.

Broadly, the apparatus may be any machine that can be driven a rotational movement.

### BRIEF DESCRIPTION OF THE DRAWINGS

Exemplary embodiments of the invention will now be described by way of example with reference to the accompanying drawings. The drawings show:

FIG. 1 are ferrite segments for a radially outer ferrite core and a radially inner ferrite core;

FIG. 2 are ferrite arranged in a radially outer ferrite core and a radially inner ferrite core;

FIG. 3 are a radially outer ferrite core and a radially inner ferrite core, with a receiving matrix;

FIG. 4 is a cross section of radially outer ferrite cores and radially inner ferrite cores arranged, with a receiving matrix;

FIG. 5 are radially outer ferrite cores and radially inner ferrite cores, with a receiving matrix;

FIG. 6 are radially outer ferrite cores and radially inner ferrite cores, with a receiving matrix;

FIG. 7 is a cross section of ferrite segments, for a radially outer ferrite core and a radially inner ferrite core as arranged relative to one another in an assembled state;

FIG. 8 is an arrangement of ferrite segments for producing a ferrite core;

FIG. 9 is a current transmission device with outer ferrite cores and inner ferrite cores;

FIG. 10 is a cross section of a separately excited synchronous machine with a current transmission device; and

FIG. 11 is an apparatus with a separately excited synchronous machine.

### DETAILED DESCRIPTION OF THE PRESENTLY PREFERRED EMBODIMENTS

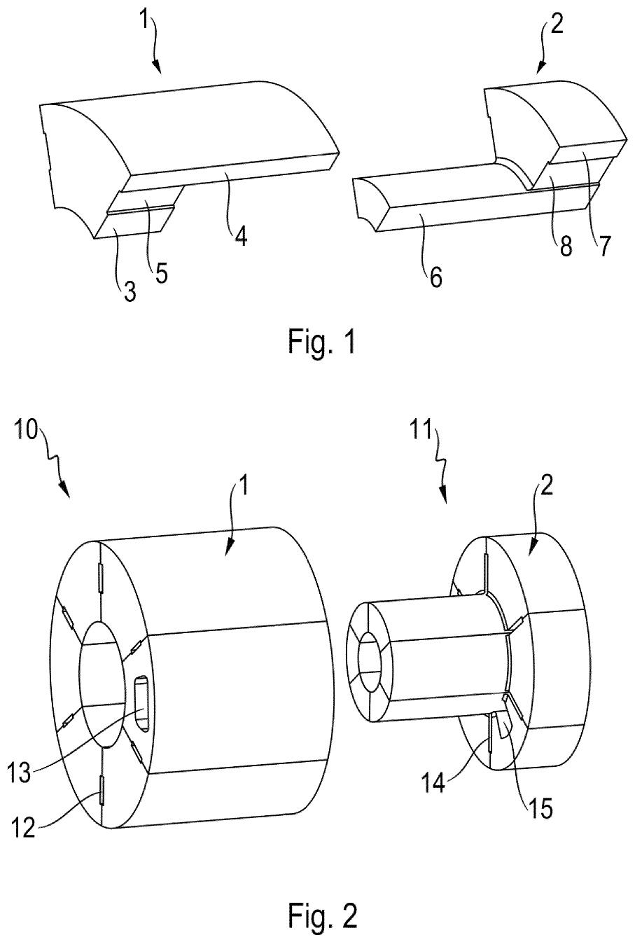

FIG. 1 shows an example of ferrite segments according to the disclosure for a radially outer ferrite core and a radially inner ferrite core.

The ferrite segment 1 for the radially outer ferrite core has a curved segment portion 4 and a segment portion 3 that is formed orthogonal to segment portion 4 and is shaped out toward the inner side of the curvature of segment portion 4.

Segment portion 3 likewise has a curvature at its radially inner surface. The curvatures of segment portion 4 and segment portion 3 are cylindrical and have the same cylinder axis.

A slot 5 is formed at segment portion 3 parallel to the orientation of segment portion 4.

The ferrite segment 2 for the radially inner ferrite core has a curved segment portion 6 and a segment portion 7 that is formed orthogonal to segment portion 6 and is shaped out towards the outer side of the curvature of segment portion 6.

Segment portion 7 likewise has a curvature at its radially outer surface. The curvatures of segment portion 6 and segment portion 7 are cylindrical and have the same cylinder axis.

A slot 8 is formed at segment portion 7 parallel to the orientation of segment portion 6.

FIG. 2 shows an embodiment example of ferrite segments according to the invention arranged in a radially outer ferrite core and a radially inner ferrite core.

The radially outer ferrite core 10 has six ferrite segments 1. One of the ferrite segments 1 has an opening 13. When the ferrite segments 1 are arranged, a cavity 12 is formed at the contact surfaces at which the slots (5 in FIG. 1) are formed.

The ferrite segments 1 are so arranged relative to one another that the curved segment portions (4 in FIG. 1) form an outer lateral surface of a cylinder. The segment portions (3 in FIG. 1) extend into the interior of the cylinder.

A coil, which can be arranged in the inner region of the radially outer ferrite core 10, can be contacted through the opening 13 or through the cavity 12. If the cavity 12 is used to contact the coil, the slots (5 in FIG. 1) can be formed deeper, as a result of which the cavity 12 is enlarged. In this case, the opening 13 need not be formed.

The radially inner ferrite core 11 has six ferrite segments 2. One of the ferrite segments 2 has an opening 15. When the ferrite segments 2 are arranged, a cavity 14 results at the contact surfaces where the slots (8 in FIG. 1) are formed.

The ferrite segments 2 are arranged relative to one another in such a way that the curved segment portions (6 in FIG. 1) form an outer lateral surface of a cylinder. The segment portions (7 in FIG. 1) extend outward out of the cylinder.

A further coil which can be arranged in the outer region of the radially inner ferrite core 11 can be contacted through the opening 15 or through the cavity 14. If the cavity 14 is used to contact the further coil, the slots (5 in FIG. 1) can be formed deeper, as a result of which the cavity 14 is enlarged. In this case, the opening 15 need not be formed.

Both the outer ferrite core 10 and the inner ferrite core 11 can be connected to a rotor of a synchronous machine and accordingly constitute the rotor of a current transmission device. Accordingly, the rotor of the synchronous machine can have coils through which current flows, and the synchronous machine can be a separately excited synchronous machine.

Consequently, the respective other ferrite core of the outer ferrite core 10 or the inner ferrite core 11 constitutes the stator of the current transmission device.

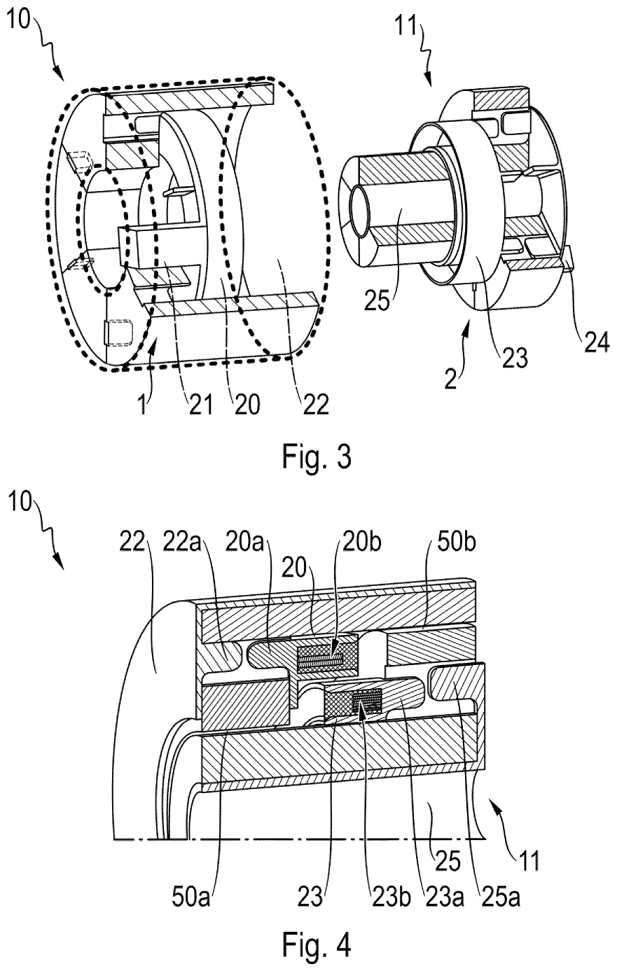

FIG. 3 shows an embodiment example of a radially outer ferrite core according to the disclosure and a radially inner ferrite core according to the disclosure with a receiving matrix.

An inner ferrite core 11 and an outer ferrite core 10 comprising ferrite segments 1 and 2 with receiving matrix 22 and 25 are shown in the drawing. The receiving matrix 22 and 15 is made of plastic.

Four ferrite segments 1 of the radially outer ferrite core 10 are shown. The ferrite segments 1 are received, and accordingly fixed, in the receiving matrix 22. In addition, a further receiving matrix 20 is shown in the interior of the radially outer ferrite core 10. The coil can be received in the further receiving matrix 20.

The receiving matrix 22 encloses the ferrite segments 1 at the cover surface and the outer lateral surface. Portions of the receiving matrix 22 also extend into the cavities (12 in FIG. 2). Accordingly, the ferrite segments 1 are received in the receiving matrix 22 and fixed by the receiving matrix 22.

The receiving matrix 20 further has a contacting channel 21 that extends through the opening (13 in FIG. 2) in the ferrite segment (not shown) outward to a cover surface of the radially outer ferrite core 10. Accordingly, contacts of the coil can be guided out to the cover surface through the contacting channel 21, and the coil can accordingly be contacted from the outside (in a state in which the inner ferrite core 11 is rotatably mounted inside of the outer ferrite core 10). The cover surface is shaped by the segment portions (3 in FIG. 1) of the ferrite segments 1.

Four ferrite segments 2 of the radially inner ferrite core 11 are shown. The ferrite segments 2 are received in the receiving matrix 25 and accordingly fixed. In addition, a further receiving matrix 23 is shown at the outer lateral surface of the radially inner ferrite core 11. The further coil can be received in the further receiving matrix 23.

Receiving matrix 25 encloses the ferrite segments 2 at their inner lateral surface and at a cover surface. Portions of the receiving matrix 25 also extend into the cavities (14 in FIG. 2). Accordingly, the ferrite segments 2 are received in the receiving matrix 25 and fixed by the receiving matrix 25.

The receiving matrix 23 further has a contacting channel 24 that extends through the opening (15 in FIG. 2) in the ferrite segment (not shown) outward to a cover surface of the radially inner ferrite core 11. Accordingly, contacts of the coil can be guided out to the cover surface through the contacting channel 24, and the coil can accordingly be contacted from the outside (in a state in which the inner ferrite core 11 is rotatably mounted inside of the outer ferrite core 10). The cover surface is shaped by the segment portions (3 in FIG. 1) of the ferrite segments 1.

In this aspect, ferrite segments 1 and 2 are held together in a positively engaging manner by receiving matrices 20 and 23 molded from plastic which simultaneously serve as a carrier or housing of the coils of the current transmission device. The coil carriers have tabs (webs) that fit into slots between the ferrite segments 1 or 2. With this design, it is possible in principle to produce the plastic body separately and only mount the components afterwards, but, again, this has disadvantages in terms of tolerances. It is also possible to position the ferrite segments, and possibly also the windings, in the injection mold and join them by overmolding to form a unit. Accordingly, the injection-molded plastic simultaneously performs the function of mechanically holding the ferrite segments and coil and providing electrical insulation.

The receiving matrices 20, 22, 24, and 25 can be made of plastic, for example, by a primary forming process such as injection molding. The ferrite segments 1 and 2 can be inserted into the receiving matrices 22 and 25, or the ferrite segments 1 and 2 can be inserted into an injection mold, aligned therein, and overmolded.

Further, the coil and the further coil can be inserted into the receiving matrices 20 and 23, or the coil and the further coil can be inserted into an injection mold, aligned therein, and overmolded.

FIG. 4 shows a cross section of an embodiment example of radially outer ferrite core and radially inner ferrite core with a receiving matrix arranged according to the disclosure.

An inner ferrite core 11 and outer ferrite core 10 comprising ferrite segments 1 and 2 with receiving matrix 22 and 25 are shown. The receiving matrix 22 and 15 is produced from plastic.

A state is illustrated in which the inner ferrite core 11 is mounted so as to be rotatably supported in the outer ferrite core 10. The rotatable bearing mount is not shown.

The radially outer ferrite core 10 is received and fixed in the receiving matrix 22. The receiving matrix 22 engages by a web 22a in a slot of a ferrite segment of the ferrite core 10.

The receiving matrix 20 receives the coil 20b and also engages via web 20a in the slot of a ferrite segment of the ferrite core. Accordingly, the coil 20b (and the receiving matrix 20) is arranged at or in the radially outer ferrite core.

The radially inner ferrite core 11 is received and fixed in the receiving matrix 25. The receiving matrix 25 engages via a web 25a in the slot of a ferrite segment of the ferrite core 11.

The receiving matrix 23 receives the coil 23b and also engages via web 23a in the slot of a ferrite segment of the ferrite core. Accordingly, the coil 23b (and the receiving matrix 23) is arranged at or outside of the radially inner ferrite core 11.

In the state in which the inner ferrite core 11 is mounted so as to be rotatably supported inside of the outer ferrite core 10, two air gaps 50a and 50b result between the inner ferrite core 11 and the outer ferrite cores 10.

Air gap 50a is formed between the segment portions (3 in FIG. 1) of the ferrite segments (1 in FIG. 1) and the segment portions (6 in FIG. 1) of the ferrite segments (2 in FIG. 1).

Air gap 50b is formed between the segment portions (7 in FIG. 1) of the ferrite segments (2 in FIG. 1) and the segment portions (4 in FIG. 1) of the ferrite segments (1 in FIG. 1).

The coils 20b and 23b are arranged in the space between the ferrite cores 10 and 11 and the air gaps 50a and 50b.

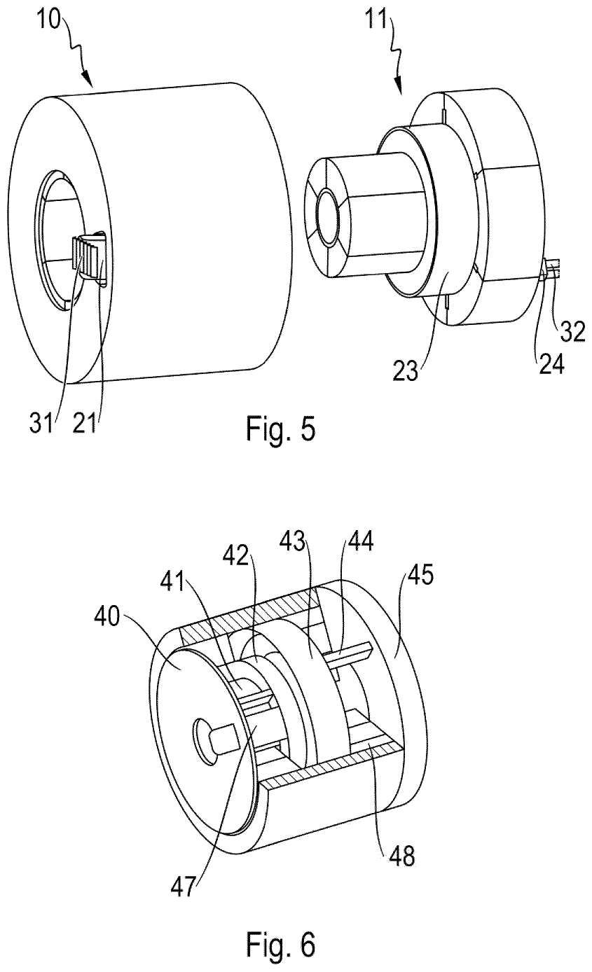

FIG. 5 shows an embodiment example of the radially outer ferrite core and radially inner ferrite core according to the disclosure with a receiving matrix.

An inner ferrite core 11 and an outer ferrite core 10 comprising ferrite segments with receiving matrix are shown in the drawing. The receiving matrix is made of plastic.

In contrast to FIG. 3, it is not possible to see inside the ferrite cores 10 and 11, since all of the ferrite segments and the receiving matrix are depicted.

Additionally, the contacts 31 and 32 of the coils protruding from the contacting channels 21 and 24 are shown.

The radially outer ferrite core alone may also be constructed in a segmented manner, particularly when segmentation of the radially inner ferrite core, owing to its smaller size and easier machinability, is not worthwhile in terms of cost and effort.

FIG. 6 shows a radially outer ferrite core and radially inner ferrite core according to the disclosure with a receiving matrix.

A modified form of the receiving matrices is shown. Components that do not depart from the previous description are not described again in order to avoid redundancy.

Receiving matrix 40, which encompasses and fixes the ferrite segments by the cover surface, and receiving matrix 42, which receives the coil, are produced in one piece herein and are connected by the webs 41. A contacting channel 47 enables the coil to be contacted in receiving matrix 42. Receiving matrix 40, webs 41, contacting channel 47 and receiving matrix 42 can be produced, for example, by overmolding the ferrite cores in an injection mold.

Receiving matrix 45, which encompasses and fixes the ferrite segments by the cover surface, and receiving matrix 43, which receives the coil, are produced in one piece herein and connected by the webs 44. A contacting channel 48 enables the coil to be contacted in receiving matrix 43. Receiving matrix 45, webs 44, contacting channel 48 and receiving matrix 43 can, for example, be produced by overmolding the ferrite cores in an injection mold.

The receiving matrix 40 and 45 holding the ferrite segments performs further tasks. The plastic injection molding 45 on the (radially outer) secondary-side ferrite core forms a circuit board carrier which is suitable for receiving a circuit board with contacting elements for connecting the secondary-side coil to adjoining electrical components and for electrically insulating from the environment.

Because receiving matrix 40 and 45 encompasses the ferrite segments from both axial sides, they are also received in a positively engaging manner. On the (radially inner) primary-side ferrite core, the plastic matrix also encompasses the segments from both sides and, in addition to the coil carrier, forms a plate which can serve as an elastic, tolerance-compensating stop for the ferrite core unit relative to adjoining components.

It is advantageous to provide the contacting channels 47 and 48 of the coil ends through the ferrite already during the overmolding of the ferrite segments. The contacting channels 47 and 48 can be located inside of a ferrite segment or in an area (slots) between two ferrite segments.

The outer ferrite core alone may also be constructed in a segmented manner, particularly when segmentation of the inner ferrite core, owing to its smaller size and easier machinability, is not worthwhile in terms of cost.

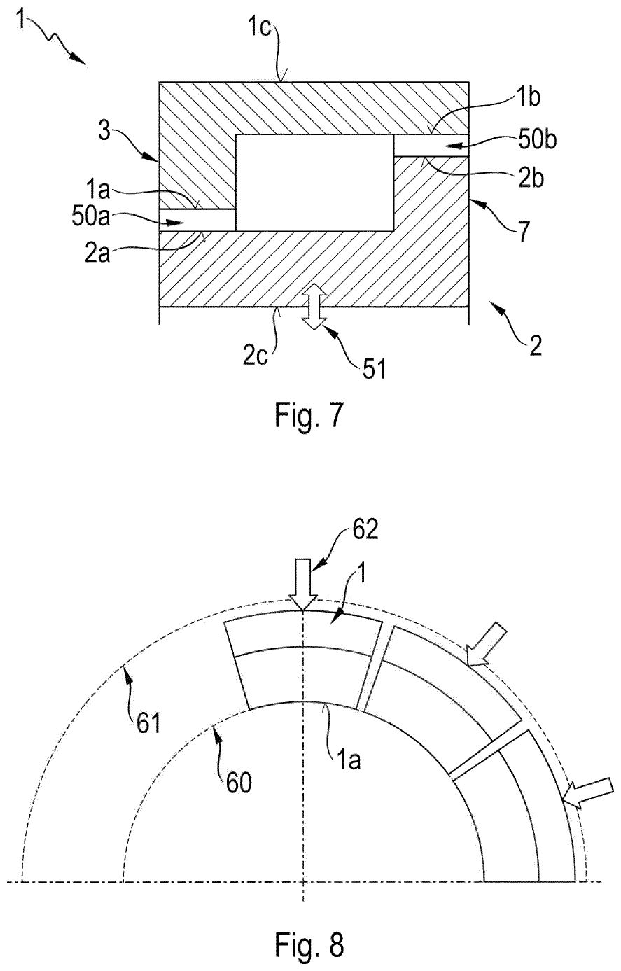

FIG. 7 shows a cross section ferrite segments according to the disclosure for a radially outer ferrite core and a radially inner ferrite core arranged relative to one another in an assembled state.

An inner ferrite core and an outer ferrite core comprising ferrite segments with receiving matrix 40 and 45 are shown in the drawing. The receiving matrix 40 and 45 is made of plastic.

Only the cross sections of the radially outer ferrite core and radially inner ferrite core, or primary-side ferrite core and secondary-side ferrite core, are shown. Both are rotationally symmetrical bodies.

The dimensions of the lateral surfaces 2c and 1c, respectively, are primarily relevant for the fit with the surrounding parts (not shown). The combination of dimensions of the lateral surfaces 1a and 2a as well as 1b and 2b determines the length (and dimensioning) of the two air gaps 50a and 50b between the ferrite cores and the ferrite segments 1 and 2.

For an inner ferrite core segment and outer ferrite core segment, unlike with closed toroidal cores, the air gap length can be changed for the individual segments by displacing, for example, the inner segment. With two toroidal cores, displacing the cores radially relative to one another would reduce the air gap in one place, but increase it by the same amount at the opposite position.

Accordingly, the geometric tolerance for one of the two air gaps can ideally be compensated up to zero by the segmentation and displacement of two segments relative to one another.

Ferrite segment 1 is a ferrite segment of the radially outer ferrite core. Accordingly, surface 1c represents the outer lateral surface of the cylindrical ferrite core. Ferrite segment 1 has two surfaces 1a and 1b located inwardly in the curvature of the ferrite segment 1 (curvature visible in FIG. 1).

Surface 1a is the curved surface at the inner end of the segment portion (3 in FIG. 1) and surface 1b is the curved surface of the segment portion (4 in FIG. 1) which is located inwardly when the ferrite core (10 in FIG. 2) is assembled.

Further, ferrite segment 2 is a ferrite segment of the radially inner ferrite core. Surface 2c is located inwardly when the ferrite core (11 in FIG. 2) is assembled. Surfaces 2a and 2b are located outwardly when the ferrite core (11 in FIG. 2) is assembled.

If the ferrite cores (10 and 11 in FIG. 4) are in a state in which they are mounted so as to be rotatably supported relative to one another, surfaces 1a and 2a lie opposite one another and the air gap 50a is formed between these surfaces. Further, surfaces 1b and 2b lie opposite one another and the air gap 50b is formed between them.

Arrow 51 represents the radial displacement of ferrite segment 2 relative to ferrite segment 1. The air gaps 50a and 50b can be decreased in this way so that an improved current transmission capacity of the current transmission device can be achieved.

The manufacturing tolerances of sintered ferrite cores which are molded, compacted, and connected to one another through the application of pressure and heat are relevant in this regard. Deformations, shrinkage or warping of the sintered ferrite cores may occur after manufacture.

Therefore, the gap width between two one-piece ferrite cores can only be controlled by extensive subsequent working, for example, by turning, milling or grinding the respective opposite surfaces 1a and 2a as well as 1b and 2b. This can be laborious particularly on inner surfaces of a hollow cylinder.

Segmented ferrite cores that are received in a receiving matrix can be positioned relative to one another by the receiving matrix. Shrinkage and warping of the pumpkin seeds can be partly compensated in this way.

If at least one segmented ferrite core is used, only one of the opposing surfaces 1a and 2a, 1b and 2b needs to be machined (for example, by turning, milling or grinding) in order to configure the two air gaps 50a and 50b with equal thickness that is constant over the entire extent thereof.

Since the radial displacement 51 of the ferrite segment 2 is made possible by the shape of receiving matrix (25 in FIG. 3 or 4), only the dimensions of the segment portions 3 and 7 need still be reworked by turning, milling or grinding. This can be done, for example, by post-machining of surfaces 1a and 2b. As a general rule, post-machining of outer surfaces requires less effort and is easier to scale to industrial production volumes.

The crucial dimension for the radially outer ferrite segment is the distance between the two lateral surfaces 1a and 1b which are relevant for the formation of the air gap. In this case, a post-machining of surface 1a would be advantageous because it is more accessible with a tool. A corresponding machining allowance should be provided on the unmachined blank. Finish machining of surface 1a to adjust a close-tolerance distance between lateral surfaces 1a and 1b also changes the distance between lateral surfaces 1a and 1c. This is compensated for in the subsequent assembly by the receiving matrix.

An analogous procedure is applied for the inner ferrite core segment.

In contrast to the displacement of ferrite segment 2 shown in FIG. 7, ferrite segment 1 can also be displaced relative to ferrite segment 2 by the receiving matrix (22 in FIGS. 3 and 4).

In general, only one of the ferrite cores need be segmented in order to configure the air gaps with equal and constant thickness over the extent thereof as was described above. In this way, the distance between the ferrite cores and, therefore, the thickness of the air gaps 50a and 50b can be minimized without risking contact between the ferrite cores during the rotating operation of the current transmission device.

FIG. 8 shows an arrangement of ferrite segments according to the disclosure for producing a ferrite core.

The diagram shows the principle according to which the individual outer ferrite segments 1 are put together to form an outer ferrite core. The ferrite segments 1 are aligned along an inner reference diameter 60. This can be accomplished in that they are pressed with a defined force 62 from the outside against a cylindrical tool insert, for example, a mandrel (not shown), which has the inner reference diameter 60.

The ferrite segments 1 are accordingly arranged via their surface 1a (compare surface 1 a in FIG. 7) at the inner reference diameter 60. The arrows 62 represent a pressing pressure which presses the ferrite segments with the surfaces 1a against the mandrel of the injection mold and fixes them therein for an injection molding process.

The cavity of the injection mold is delimited, for example, by the mandrel at the inner reference diameter 60 and by a wall at the outer reference diameter 61. Further delimitation of the cavity can be formed in such a way, for example, that a cover surface (40 or 45 in FIG. 6) and receiving matrix (42 or 43 in FIG. 6) for a coil are provided.

Consequently, the actual dimension of the resulting lateral surfaces 1a of the assembled segments corresponds very closely to the inner reference diameter. Further, the ferrite segments 1 are dimensioned so that their outer contours lie inside of the outer reference diameter 61 of the assembled core. In order to hold the ferrite segments 1 in position outside the injection mold, they are overmolded with a receiving matrix made, for example, of plastic, after alignment.

The injection mold is configured such that the outer diameter of the resulting plastic matrix corresponds to the outer reference diameter of the resulting core. A tighter tolerance can be achieved with plastics injection molding than with a sintered ferrite core. If this is not sufficient, mechanical reworking is easier and less costly with plastic than with ferrite.

When a receiving matrix is injection molded, e.g., from plastic, a ferrite core of ferrite segments that are received in a receiving matrix is produced.

If the inner reference diameter 60 and outer reference diameter 61 correspond to the desired dimensions of the ferrite core, no post-machining need take place after the injection molding process of the receiving matrix. Only the surfaces 1a of the ferrite segments 1 may be post-machined, for example, by milling or grinding, after sintering the ferrite segments 1 and before the injection molding process of the receiving matrix.

A post-machining of surfaces 1a after the injection molding process of the receiving matrix is possible also, for example, but is more complicated because an inner wall of a hollow cylinder is machined. However, surface 1b of the ferrite segments 1 can then be used to align and fix the ferrite segments 1 at a larger reference diameter than the inner reference diameter 60.

Referring to FIG. 8, a possibility for producing a radially outer ferrite core (10 in FIG. 5) was described. This possibility is applicable in the same way for producing the assembled radially inner ferrite core (11 in FIG. 5).

For this purpose, the ferrite segments 2 can be aligned either with surface 2a or with surface 2b at an outer wall of an injection mold, which outer wall represents an outer reference diameter, and then embedded in the receiving matrix in an injection molding process.

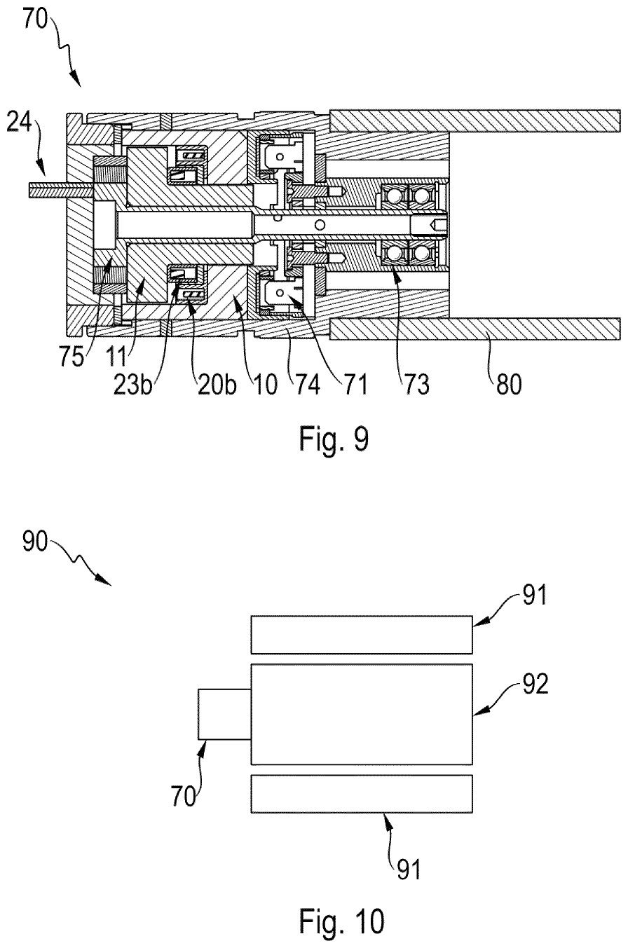

FIG. 9 shows a current transmission device with outer ferrite core and inner ferrite core according to the disclosure.

An inductive current transmission device for a separately excited synchronous machine is shown.

The current transmission device 70 has a radially inner ferrite core 11 comprising a receiving matrix and ferrite segments, as well as a coil 23b and a contacting channel 24. Further, the current transmission device 70 has a radially outer ferrite core 10 comprising a receiving matrix and ferrite segments, and a coil 20b (contacting channel is not shown). The current transmission device 70 further comprises a hollow shaft 74 and an axle 75.

The hollow shaft 74 is connected to the radially outer ferrite core 10. Further, the hollow shaft 74 is connected to a shaft 80. This shaft 80 may be a shaft of a rotor of a synchronous machine.

The axle 75 is connected to the radially inner ferrite core 11. The axle 75 is also connected to the bearings 73. The bearings 73 are in turn connected in the hollow shaft 74 of the outer ferrite core 10. Accordingly, the radially inner ferrite core 11 and the radially outer ferrite core 10 are bearing-mounted relative to one another and are accordingly also connected to one another in a rotatably supported manner. The axle 75 can be part of the stator of a synchronous machine.

A cavity 71 can contain electronics and circuits (or function as a circuit board carrier) which in turn control coils of a rotor connected to the shaft 80 or surrounding the shaft 80 on the basis of the current transmitted by induction between the coils 23b and 20b.

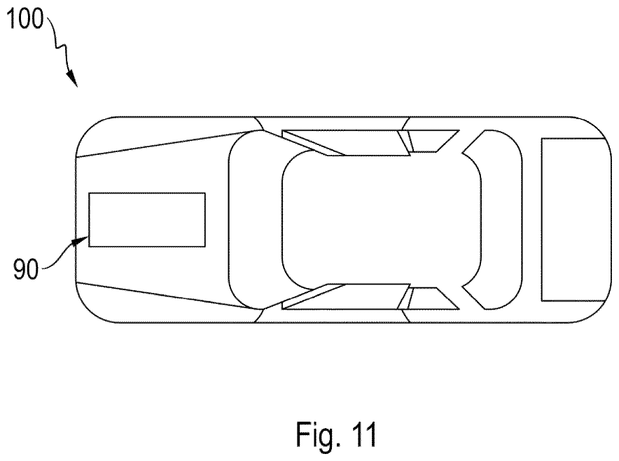

FIG. 10 shows a cross section of a separately excited synchronous machine with a current transmission device.

A separately excited synchronous machine 90 has a stator 91 and a rotor 92. The current transmission device 70 is fitted to the rotor 92 and transmits current to the rotor 92.

FIG. 11 shows an apparatus with a separately excited synchronous machine.

The apparatus 100, constructed as a vehicle, has a separately excited synchronous machine 90. This separately excited synchronous machine 90 in turn has the current transmission device (not shown).

The apparatus 100 is depicted here as a passenger car, but may include any form of goods transport or passenger transport, for example, trucks, vans, buses, trains, subways, trams, boats, and ships.

Further, the apparatus 100 may comprise, for example, work machines, such as, e.g., construction vehicles, forestry vehicles and agricultural vehicles, as well as construction machines, forestry machines and agricultural machines.

For example, the apparatus 100 may be a machine from the domain of conveying engineering or a machine of a production installation.

Broadly, the apparatus 100 may be any machine that can be driven by a rotational movement.

The depicted embodiment examples are to be understood as a further elucidation of the present invention. A combination of the embodiment examples is envisaged. For the exact scope of the invention, reference is made to the following claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A current transmission device for a separately excited synchronous machine comprising:
a stator comprising a ferrite core;
a rotor connected to the stator in rotatably supported manner and comprising a further ferrite core;
at least one coil arranged at the ferrite core;
at least one further coil arranged at the further ferrite core; and
at least one of the ferrite cores comprises a plurality of ferrite segments which are receivable in a receiving matrix such that current can be transmitted contactlessly between the coil and the further coil by induction.

12. The current transmission device according to claim 11, wherein the receiving matrix is made of plastic.

13. The current transmission device according to claim 11, wherein the receiving matrix is produced by a primary forming process, and the ferrite segments are embedded in the primary forming process.

14. The current transmission device according to claim 11, wherein the ferrite segments have slots which, in an installed state, are at least partially filled by the receiving matrix.

15. The current transmission device according to claim 14, wherein at least the coil or the further coil are contacted through at least one slot arranged between two ferrite segments of the respective ferrite core, wherein the coil or the further coil can be arranged at the ferrite core through whose slot it can be contacted.

16. The current transmission device according to claim 11,
wherein at least the coil or the further coil can be contacted through an opening that is arranged in one of the ferrite segments, or, if the ferrite core is not segmented, that is arranged in the ferrite core, and
wherein the coil or the further coil can be arranged at the ferrite core through whose opening it can be contacted.

17. The current transmission device according to claim 11,
wherein the ferrite core can be arranged radially inside the further ferrite core, or the ferrite core are arranged radially inside the ferrite core,
wherein, two air gaps are formed between the ferrite core and the further ferrite core, which two air gaps are located at both axial ends of the ferrite cores and are formed between outer lateral surfaces of the radially inner ferrite core and the inner lateral surfaces of the radially outer ferrite core, and
wherein the coil and the further coil can be arranged in a space between the two air gaps.

18. The current transmission device according to claim 11, wherein the stator ferrite segments and rotor ferrite segments are of unequal width such that, at every angle of rotation, a sum of opposing ferrite segment lateral surfaces of the ferrite core and of an other ferrite core remains constant.

19. A separately excited synchronous machine with a current transmission device comprising:
a stator comprising a ferrite core;
a rotor connected to the stator in rotatably supported manner and comprising a further ferrite core;
at least one coil arranged at the ferrite core;
at least one further coil arranged at the further ferrite core; and
at least one of the ferrite cores comprises a plurality of ferrite segments which are receivable in a receiving matrix such that current can be transmitted contactlessly between the coil and the further coil by induction.

20. An apparatus with a separately excited synchronous machine with a current transmission device comprising:
a stator comprising a ferrite core;
a rotor connected to the stator in rotatably supported manner and comprising a further ferrite core;
at least one coil arranged at the ferrite core;
at least one further coil arranged at the further ferrite core; and
at least one of the ferrite cores comprises a plurality of ferrite segments which are receivable in a receiving matrix such that current can be transmitted contactlessly between the coil and the further coil by induction.

21. The current transmission device according to claim 13, wherein the primary forming process, is injection molding.
